(19) United States
(12) Patent Application Publication
(10) Pub. No.: US 2016/0107382 A1
(43) Pub. Date: Apr. 21, 2016

(54) THREE-DIMENSIONALLY SHAPED ARTICLE PRODUCTION METHOD, THREE-DIMENSIONALLY SHAPED ARTICLE PRODUCTION APPARATUS, AND THREE-DIMENSIONALLY SHAPED ARTICLE

(71) Applicant: SEIKO EPSON CORPORATION, Tokyo (JP)

(72) Inventor: Hiroshi WADA, Azumino-shi (JP)

(21) Appl. No.: 14/882,544

(22) Filed: Oct. 14, 2015

(30) Foreign Application Priority Data
Oct. 17, 2014 (JP) 2014-212570

(51) Int. Cl. B29C 67/00

(52) U.S. Cl. CPC B29C 67/0059; B29C 67/0092; B33Y 10/00

(57) ABSTRACT

A three-dimensionally shaped article production method according to the invention is a method for producing a three-dimensionally shaped article by stacking a layer, and includes: ejecting a curable ink containing a UV curable resin, thereby forming the layer; irradiating the ejected curable ink with an ultraviolet ray; and flattening the layer by removing at least a part of the layer.

### BACKGROUND

1. Technical Field

The present invention relates to a three-dimensionally shaped article production method, a three-dimensionally shaped article production apparatus, and a three-dimensionally shaped article.

2. Related Art

There has been known a method for forming a three-dimensionally shaped article based on a model of a three-dimensional object formed with, for example, three-dimensional CAD software or the like.

As one method for forming a three-dimensionally shaped article, a stacking method is known (for example, see JP-A-2000-280354). In the stacking method, generally, after a model of a three-dimensional object is divided into a plurality of two-dimensional cross-sectional layers, cross-sectional members corresponding to the respective two-dimensional cross-sectional layers are sequentially shaped and sequentially stacked, whereby a three-dimensionally shaped article is formed.

The stacking method can immediately form a three-dimensionally shaped article as long as there is a model of the three-dimensionally shaped article to be shaped, and it is not necessary to form a mold or the like prior to shaping, and therefore, it is possible to form a three-dimensionally shaped article promptly at low cost. Further, since shaping is performed by staking thin plate-shaped cross-sectional members one by one, even in the case of a complicated object having, for example, an internal structure, the object can be shaped as an integrated shaped article without being divided into a plurality of components.

Meanwhile, in the method of the related art, according to the slice data (two-dimensional data) of each layer obtained by finely cutting the three-dimensional data of a three-dimensionally shaped article into slices, a curable ink is ejected to form layers, and the formed layers are stacked, thereby forming the shaped article. However, in the case where layers are formed by ejecting a curable ink, there was a problem that a variation in the thickness occurs due to a variation in the ejection of the curable ink, curing shrinkage thereof, etc. As a result, there was a problem that the dimensional accuracy of the finally obtained three-dimensionally shaped article is deteriorated.

### SUMMARY

An advantage of some aspects of the invention is to provide a three-dimensionally shaped article production method and a three-dimensionally shaped article production apparatus capable of efficiently producing a three-dimensionally shaped article with high dimensional accuracy, and to provide a three-dimensionally shaped article produced with high dimensional accuracy.

Such an advantage is achieved by the invention described below.

A three-dimensionally shaped article production method according to an aspect of the invention is a method for producing a three-dimensionally shaped article by stacking a layer, and includes: an ink ejection step of ejecting a curable ink containing a UV curable resin, thereby forming the layer; a UV irradiation step of irradiating the ejected curable ink with an ultraviolet ray; and a flattening step of flattening the layer by removing at least a part of the layer.

According to this, a three-dimensionally shaped article can be efficiently produced with high dimensional accuracy.

In the three-dimensionally shaped article production method according to the aspect of the invention, it is preferred that in the flattening of the layer, after stacking a plurality of the layers, at least a part of the uppermost layer and the lower layer of the uppermost layer of the plurality of the layers are removed.

According to this, a three-dimensionally shaped article can be efficiently produced with high dimensional accuracy.

In the three-dimensionally shaped article production method according to the aspect of the invention, it is preferred that in the ejecting of a curable ink, a sacrifice layer forming ink containing a UV curable resin for forming a sacrifice layer is ejected into a region, which is adjacent to a region to become the outermost layer of the three-dimensionally shaped article, and is on the surface side of the outermost layer.

According to this, a three-dimensionally shaped article can be produced with higher dimensional accuracy.

In the three-dimensionally shaped article production method according to the aspect of the invention, it is preferred that in the flattening of the layer, the layer including the sacrifice layer is flattened.

According to this, the dimensional accuracy of the obtained three-dimensionally shaped article can be further enhanced.

In the three-dimensionally shaped article production method according to the aspect of the invention, it is preferred that the flattening of the layer is performed using one member selected from the group consisting of a rotary cutter, an end mill, a grinder, and a laser.

According to this, a three-dimensionally shaped article can be produced with higher dimensional accuracy.

A three-dimensionally shaped article production apparatus according to an aspect of the invention is an apparatus for producing a three-dimensionally shaped article by stacking a layer, and includes: a shaping section in which the three-dimensionally shaped article is shaped; an ejection section which ejects a curable ink containing a UV curable resin, thereby forming the layer on the shaping section; a UV irradiation section which irradiates the ejected curable ink with an ultraviolet ray; and a flattening unit which flattens the layer by removing at least a part of the layer.

According to this, a three-dimensionally shaped article can be efficiently produced with high dimensional accuracy.

A three-dimensionally shaped article according to an aspect of the invention is produced by the three-dimensionally shaped article production method according to the aspect of the invention.

According to this, a three-dimensionally shaped article produced with high dimensional accuracy can be provided.

A three-dimensionally shaped article according to an aspect of the invention is produced with the three-dimensionally shaped article production apparatus according to the aspect of the invention.

According to this, a three-dimensionally shaped article produced with high dimensional accuracy can be provided.

### BRIEF DESCRIPTION OF THE DRAWINGS

The invention will be described with reference to the accompanying drawings, wherein like numbers reference like elements.

FIGS. 1A to 1F are process diagrams showing a preferred embodiment of a three-dimensionally shaped article production method according to the invention by cross-sectional views.

FIG. 2 is a side view showing a preferred embodiment of a three-dimensionally shaped article production apparatus according to the invention.

### DESCRIPTION OF EXEMPLARY EMBODIMENTS

Hereinafter, preferred embodiments of the invention will be described in detail with reference to the accompanying drawings.

### 1. Three-Dimensionally Shaped Article Production Method

First, a three-dimensionally shaped article production method according to the invention will be described.

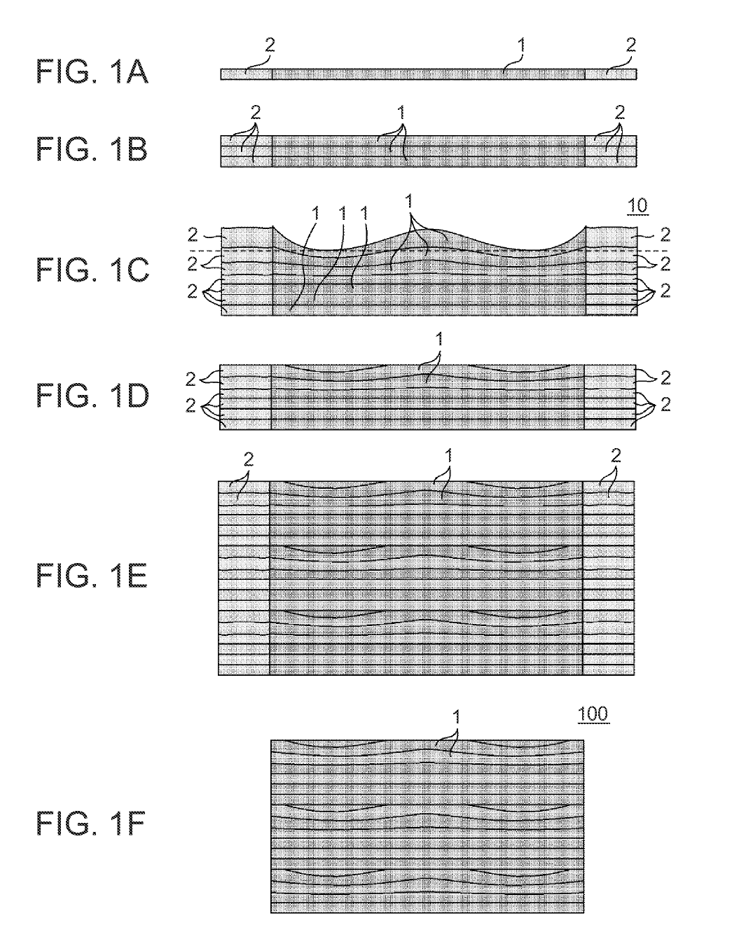

FIGS. 1A to 1F are process diagrams showing a preferred embodiment of a three-dimensionally shaped article production method according to the invention by cross-sectional views.

A three-dimensionally shaped article production method according to this embodiment is a method for producing a three-dimensionally shaped article by stacking a layer 1, and includes: an ink ejection step of ejecting a curable ink containing a UV curable resin, thereby forming the layer 1, and also ejecting a sacrifice layer forming ink containing a UV curable resin into a region, which is adjacent to a region to become the outermost layer of a three-dimensionally shaped article 100, and is on the surface side of the outermost layer, thereby forming a sacrifice layer 2; a UV irradiation step of irradiating the layer 1 and the sacrifice layer 2 with an ultraviolet ray; a stacking step of stacking the layer 1 and the sacrifice layer 2 by repeating the ink ejection step and the UV irradiation step; a flattening step of flattening a stacked body 10 of the layer 1 and the sacrifice layer 2 by removing at least a part of the stacked body 10; and a sacrifice layer 2 removing step of removing the sacrifice layers 2.

Incidentally, in the case where the layers are formed by using the curable ink and the sacrifice layer forming ink, there was a problem that a variation in the thickness within the layer or between the layers (the layer 1 and the sacrifice layer 2) occurs due to a variation in the ejection amount among inkjet nozzles, curing shrinkage of the inks, a difference in the curing shrinkage between the inks, etc. As a result, there was a problem that the dimensional accuracy of the finally obtained three-dimensionally shaped article is deteriorated.

On the other hand, according to the invention, after forming the layers in the ink ejection step and curing the layers in the UV irradiation step, at least apart of the layers is removed to flatten the layers, whereby the occurrence of a variation in the thickness within the layer or between the layers due to the variation in the ejection amount (ejection amount, flight curve) and curing shrinkage can be prevented. As a result, a three-dimensionally shaped article can be efficiently produced with high dimensional accuracy. On the other hand, when the flattening step is performed before curing the layers in the UV irradiation step, the curable ink or the sacrifice layer forming ink flows or is pushed out, and the ink may be spread over the adjacent curable ink or sacrifice layer forming ink in some cases. Further, curing shrinkage also occurs in the UV irradiation step, and therefore, the dimensional accuracy of the finally obtained three-dimensionally shaped article is deteriorated.

Hereinafter, the respective steps will be described.

### Ink Ejection Step

In the ink ejection step, an inkjet method is used, and the curable ink and the sacrifice layer forming ink are ejected in a given pattern by the inkjet method.

More specifically, the curable ink is ejected into a region (a shaping section 1100) where the three-dimensionally shaped article 100 is formed. By doing this, the layer 1 is formed (see FIG. 1A). Further, the curable ink is ejected and also the sacrifice layer forming ink is ejected into a region, which is adjacent to a region to become the outermost layer of the three-dimensionally shaped article 100, and is on the surface side of the outermost layer. By doing this, the sacrifice layer 2 is formed (see FIG. 1A).

By forming the sacrifice layer 2 in this manner, the curable ink is prevented from undesirably flowing out from the region where the three-dimensionally shaped article 100 is to be formed, and thus, the dimensional accuracy can be further enhanced.

Further, by forming the sacrifice layer 2, even if a layer (second layer) constituting the three-dimensionally shaped article 100 has a portion protruding from the outer peripheral portion of the layer (first layer) lower than this layer (for example, a shape in which the size of the three-dimensionally shaped article increases upward), the sacrifice layer 2 as the lower layer (first layer) can favorably support the curable ink for forming the upper layer (second layer). As a result, even a three-dimensionally shaped article 100 having a complicated shape can be easily produced.

Further, in this step, the inks (the curable ink and the sacrifice layer forming ink) are applied by an inkjet method, and therefore, even if the pattern in which the inks (the curable ink and the sacrifice layer forming ink) are applied has a fine shape, the inks can be applied to a predetermined position with high reproducibility. As a result, the dimensional accuracy of the finally obtained three-dimensionally shaped article 100 can be made particularly high.

The curable ink and the sacrifice layer forming ink will be described in detail later.

### UV Irradiation Step (Curing Step)

Subsequently, the formed layer 1 and sacrifice layer 2 are irradiated with an ultraviolet ray.

By doing this, the layer 1 and the sacrifice layer 2 are cured.

In the above explanation, it is described that the respective inks are applied in a shape and a pattern corresponding to the layer 1 and the sacrifice layer 2, and thereafter, the entire layers constituted by the respective inks are cured, however, in the invention, in at least a part of the region, the ejection of the ink and the curing of the ink may be performed concurrently. That is, before forming the entire pattern of the layer 1 and the sacrifice layer 2, a curing reaction may be allowed to sequentially proceed from a portion where the respective inks are applied.

Further, at the time of completion of this step, the curable ink may be brought to a semi-cured state such that the curable ink is in an incomplete state (with no fluidity). Even in such a case, for example, after performing a subsequent step (for example, the “ink ejection step” or the like after forming the layer 1 on the lower side in the curing step), by performing a main curing treatment for increasing the curing degree for the curable ink in a semi-cured state, the mechanical strength and the like of the finally obtained three-dimensionally shaped article 100 can be made excellent. Further, by applying the ink for forming the upper layer to the curable ink (lower layer) in a semi-cured state, the adhesiveness between the layers can be made particularly excellent.

### Stacking Step

In this step, the layer 1 and the sacrifice layer 2 are stacked by repeating the ink ejection step and the UV irradiation step (see FIGS. 1B and 1C). By doing this, the stacked body 10 is formed.

### Flattening Step

Subsequently, the surface of the stacked body 10 (layer 1) is flattened.

In the surface of the stacked body 10, a variation in the thickness of the respective layers 1 (sacrifice layers 2) occurs, and therefore, large irregularities are generated. In the case where the three-dimensionally shaped article 100 is produced in this state, there was a problem that the dimensional accuracy of the finally obtained three-dimensionally shaped article is deteriorated.

In the invention, by removing a part of the layer 1, the surface of the stacked body 10 (layer 1) is flattened, and therefore, the three-dimensionally shaped article 100 can be produced with high dimensional accuracy.

Specifically, by removing a portion above the dotted line shown in FIG. 1C, the surface of the stacked body 10 (layer 1) is flattened as shown in FIG. 1D. That is, after a plurality of the layers are stacked, by removing at least a part of the uppermost layer and the lower layer of the uppermost layer, the surface of the stacked body 10 (layer 1) is flattened. By doing this, the three-dimensionally shaped article 100 can be produced with high dimensional accuracy and with higher productivity than in the case where the removal of a part of the layer 1 is performed for each layer. An ejection section 1101 may be a line head.

A flattening unit to be used for removing a part of the layer 1 is not particularly limited, however, it is preferred to use one member selected from the group consisting of a rotary cutter, an end mill, a grinder, and a laser. By using this member, the surface of the layer 1 can be more efficiently flattened.

In the removal of a part of the layer 1, the removal of an unnecessary portion for flattening is started from the surface (side surface) of the sacrifice layer 2. In the removal of the layer 1 and the sacrifice layer 2, a rotary cutter, an end mill, and a grinder can be adjusted so that the rotation speed differs depending on the physical properties (hardness, brittleness) of the resin. Further, also a laser can be adjusted so that the output value differs depending on the physical properties (hardness, brittleness) of the resin in the same manner.

At an interface between an end portion of the layer 1 and an end portion of the sacrifice layer 2, these layers are supported to each other, and therefore, by a flattening unit as described above, the occurrence of a defect at a corner portion of the stacked body 10 (layer 1) on the surface side of the three-dimensionally shaped article 100 can be effectively prevented. As a result, the dimensional accuracy of the obtained three-dimensionally shaped article 100 can be further enhanced.

Thereafter, by repeating the ink ejection step, the UV irradiation step, the stacking step, and the flattening step, the three-dimensionally shaped article 100 surrounded by the sacrifice layer 2 is obtained (FIG. 1E).

### Sacrifice Layer Removing Step

Subsequently, the sacrifice layer 2 is removed (FIG. 1F).

By doing this, the three-dimensionally shaped article 100 having excellent dimensional accuracy is obtained.

Examples of a method for removing the sacrifice layer 2 include a method in which the sacrifice layer 2 is selectively dissolved and removed by using a liquid which selectively dissolves the sacrifice layer 2, and a method in which a liquid for which the sacrifice layer 2 has higher absorbability than the main body of the three-dimensionally shaped article 100 is used, and the sacrifice layer 2 is made to selectively absorb the liquid to swell the sacrifice layer 2, or to decrease the mechanical strength of the sacrifice layer 2, and then, the sacrifice layer 2 is detached or disrupted.

The liquid to be used in this step varies depending on the constituent materials or the like of the respective layers, however, for example, water, an alcohol such as methanol, ethanol, isopropyl alcohol, n-propyl alcohol, butanol, or isobutanol, glycerin, a glycol such as ethylene glycol, diethylene glycol, triethylene glycol, propylene glycol, or dipropylene glycol, or the like can be used. The liquid contains at least one member selected from these, and may be a liquid mixed with a water-soluble substance which generates a hydroxide ion such as sodium hydroxide, potassium hydroxide, sodium hydrogen carbonate, or an organic amine for increasing the solubility of the sacrifice layer 2, a surfactant which facilitates the separation of the detached sacrifice layer, or the like.

A method for applying the liquid to the sacrifice layer 2 is not particularly limited, and for example, a soaking method, a spraying method, a coating method, a variety of printing methods, and the like can be adopted.

In the above explanation, it is described that the liquid is used, however, a substance (for example, a solid, a gas, a supercritical fluid, or the like) having the same function may be used.

Further, when or after the liquid is applied, ultrasonic vibration may be applied. By doing this, the removal of the sacrifice layer 2 can be accelerated, and thus, the productivity of the three-dimensionally shaped article 100 can be made particularly excellent.

In the above explanation, it is described that the sacrifice layer forming ink is applied so as to come in contact with the curable ink in the entire region which is to become the outermost layer of the three-dimensionally shaped article 100, however, the sacrifice layer forming ink may be applied so as to come in contact with the curable ink only in a part of the region which is to become the outermost layer of the three-dimensionally shaped article 100.

Further, in the above explanation, a case where the sacrifice layer 2 is provided is described, however, the sacrifice layer 2 may not be provided.

Further, in the above explanation, it is described that after stacking a plurality of the layers 1, the flattening treatment is performed, however, the flattening treatment may be performed every time each layer is formed.

### 2. Three-Dimensionally Shaped Article Production Apparatus

Next, a preferred embodiment of a three-dimensionally shaped article production apparatus according to the invention will be described.

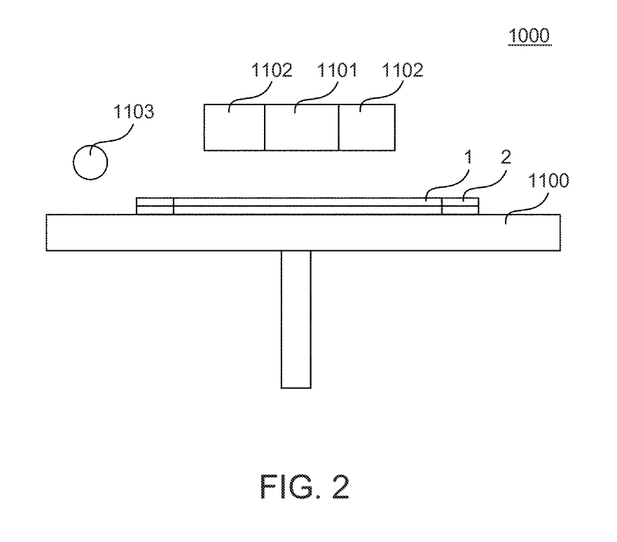

FIG. 2 is a side view showing a preferred embodiment of a three-dimensionally shaped article production apparatus according to the invention.

A three-dimensionally shaped article production apparatus 1000 is an apparatus for producing a three-dimensionally shaped article by stacking a layer 1 formed by ejecting a curable ink containing a UV curable resin.

As shown in FIG. 2, the three-dimensionally shaped article production apparatus 1000 includes a shaping section 1100 in which a three-dimensionally shaped article 100 is shaped; an ejection section 1101 which ejects a curable ink and a sacrifice layer forming ink, each containing a UV curable resin into the shaping section 1100, thereby forming a layer 1 and a sacrifice layer 2 on the shaping section 1100; a UV irradiation unit 1102 which irradiates the layer 1 and the sacrifice layer 2 with an ultraviolet ray; and a flattening unit 1103 which flattens the surface of the layer 1 by removing a part of the surface of the layer 1.

The shaping section 1100 is a region where the curable ink and the sacrifice layer forming ink are applied. Then, on the shaping section 1100, the layer 1 and the sacrifice layer 2 are formed and stacked.

By moving the shaping section 1100 downward in the drawing, the layer 1 and the sacrifice layer 2 can be stacked. Further, by allowing the shaping section 1100 to pass on the lower side in the vertical direction of the flattening unit 1103, the surface of the stacked body 10 (layer 1) may be flattened. In this case, in FIG. 2, the ejection section 1101 ejects the ink while moving in the vertical direction with respect to the paper surface, and the shaping section 1100 moves on the lower side in the vertical direction of the flattening unit 1103, whereby the ejection and flattening can be simultaneously performed, and thus, the three-dimensionally shaped article 100 can be produced with high productivity and with high dimensional accuracy.

The surface of the shaping section 1100 is subjected to a liquid repellent treatment such as a fluorine treatment, so as to have a structure that the curable ink and the sacrifice layer forming ink hardly adhere thereto. The liquid repellent treatment such as a fluorine treatment may not be performed for the entire surface of the shaping section 1100, and for example, a grid pattern, a linear pattern, a circular pattern, or the like may be adopted. A pattern portion may be a liquid repellent treated portion or a liquid repellent untreated portion, and different patterns may be combined.

The ejection section 1101 has a function to eject the curable ink and the sacrifice layer forming ink into the shaping section 1100. Further, the ejection section 1101 may be configured such that a distance to the shaping section 1100 is adjusted by moving in the vertical direction in the drawing.

The ejection section 1101 is mounted with a liquid droplet ejection head which ejects a liquid droplet of each ink by an inkjet method. Further, the ejection section 1101 includes a curable ink supply section (not shown) and a sacrifice layer forming ink supply section (not shown). In this embodiment, a liquid droplet ejection head using a so-called piezoelectric drive system is adopted. The liquid droplet ejection head includes a plurality of nozzle arrays from which the curable ink is ejected and a plurality of nozzle arrays from which the sacrifice layer forming ink is ejected, and on the uppermost stream side and the lowermost stream side of the scanning direction of the ejection section 1101, the nozzle arrays for the sacrifice layer forming ink are disposed. According to this, high productivity of the three-dimensionally shaped article 100 can be achieved, and the three-dimensionally shaped article 100 can be produced with high dimensional accuracy.

The UV irradiation unit 1102 has a function to cure the UV curable resin in the layer 1 and the sacrifice layer 2 by irradiating the layer 1 and the sacrifice layer 2 with an ultraviolet ray.

This UV irradiation unit 1102 is provided on both ends of the ejection section 1101. Further, the UV irradiation unit 1102 may be configured such that an irradiation distance to each of the layer 1 and the sacrifice layer 2 is adjusted by moving the UV irradiation unit 1102 in the vertical direction in the drawing independently of the ejection section 1101.

The flattening unit 1103 has a function to flatten the layer 1 by removing at least a part of the surface of the layer 1. The flattening can be performed by moving the flattening unit 1103 in a direction parallel to or intersecting the inkjet nozzle array. Preferably, it is desired to move the flattening unit 1103 in a direction parallel to the direction of the nozzle array. According to this, for example, a removed material of the layer 1 is prevented from adhering to the inkjet nozzle, and thus, the three-dimensionally shaped article 100 can be produced with high productivity and with high dimensional accuracy.

According to the three-dimensionally shaped article production apparatus 1000 having the configuration as described above, the variation in the thickness of the layer 1 can be decreased. As a result, the three-dimensionally shaped article can be produced with high dimensional accuracy.

### 3. Curable Ink

The curable ink contains at least a UV curable resin.

### UV Curable Resin

As the UV curable resin (polymerizable compound), a compound whose addition polymerization or ring-opening polymerization is initiated by a radical species, a cationic species, or the like generated from a photopolymerization initiator by UV irradiation, thereby forming a polymer is preferably used. Examples of the polymerization form of the addition polymerization include radical, cationic, anionic, metathesis, and coordination polymerization. Further, examples of the polymerization form of the ring-opening polymerization include cationic, anionic, radical, metathesis, and coordination polymerization.

Examples of the addition polymerizable compound include compounds having at least one ethylenically unsaturated double bond. As the addition polymerizable compound, a compound having at least one, preferably two or more terminal ethylenically unsaturated bonds can be preferably used.

An ethylenically unsaturated polymerizable compound has a chemical form of a monofunctional polymerizable compound, a polyfunctional polymerizable compound, or a mixture thereof. Examples of the monofunctional polymerizable compound include unsaturated carboxylic acids (for example, acrylic acid, methacrylic acid, itaconic acid, crotonic acid, isocrotonic acid, maleic acid, etc.) and esters thereof, and amides thereof. As the polyfunctional polymerizable compound, an ester of an unsaturated carboxylic acid with an aliphatic polyhydric alcohol compound or an amide of an unsaturated carboxylic acid with an aliphatic polyvalent amine compound is used.

Further, an addition reaction product of an ester or an amide of an unsaturated carboxylic acid having a hydroxyl group or a nucleophilic substituent such as an amino group or a mercapto group with an isocyanate or an epoxy, a dehydration condensation reaction product with a carboxylic acid, or the like can also be used. Further, an addition reaction product of an ester or an amide of an unsaturated carboxylic acid having an electrophilic substituent such as an isocyanate group or an epoxy group with an alcohol, an amine, or a thiol, further, a substitution reaction product of an ester or an amide of an unsaturated carboxylic acid having a leaving substituent such as a halogen group or a tosyloxy group with an alcohol, an amine, or a thiol can also be used.

As a specific example of the radical polymerizable compound which is the ester of an unsaturated carboxylic acid with an aliphatic polyhydric alcohol compound, for example, a (meth)acrylate ester is representative, and either a monofunctional (meth)acrylate or a polyfunctional (meth)acrylate can be used.

Specific examples of the monofunctional (meth)acrylate include phenoxyethyl(meth)acrylate, phenyloxyethyl(meth)acrylate, cyclohexyl(meth)acrylate, ethyl(meth)acrylate, methyl(meth)acrylate, isobornyl(meth)acrylate, tetrahydrofurfuryl(meth)acrylate, and 4-hydroxybutyl(meth)acrylate.

Specific examples of a difunctional (meth)acrylate include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, dipentaerythritol di(meth)acrylate, 2-(2-vinyloxyethoxy)ethyl(meth)acrylate, dipropylene glycol diacrylate, and tripropylene glycol diacrylate.

Specific examples of a trifunctional (meth)acrylate include trimethylolpropane tri(meth)acrylate, trimethylolethane tri(meth)acrylate, alkylene oxide-modified tri(meth)acrylate of trimethylolpropane, pentaerythritol tri(meth)acrylate, dipentaerythritol tri(meth)acrylate, trimethylolpropane tri((meth)acryloyloxypropyl) ether, isocyanuric acid alkylene oxide-modified tri(meth)acrylate, propionic acid dipentaerythritol tri(meth)acrylate, tri((meth)acryloyloxyethyl) isocyanurate, hydroxypivalaldehyde-modified dimethylolpropane tri(meth)acrylate, and sorbitol tri(meth)acrylate.

Specific examples of a tetrafunctional (meth)acrylate include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Specific examples of a pentafunctional (meth)acrylate include sorbitol penta(meth)acrylate and dipentaerythritol penta(meth)acrylate.

Specific examples of a hexafunctional (meth)acrylate include dipentaerythritol hexa(meth)acrylate, sorbitol hexa(meth)acrylate, alkylene oxide-modified hexa(meth)acrylate of phosphazene, and caprolactone-modified dipentaerythritol hexa(meth)acrylate.

Examples of the polymerizable compound other than (meth)acrylates include itaconate esters, crotonate esters, isocrotonate esters, and maleate esters.

Examples of the itaconate esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of the crotonate esters include ethylene glycol dicrotonate, tetramethylene glycol dicrotonate, pentaerythritol dicrotonate, and sorbitol tetradicrotonate.

Examples of the isocrotonate esters include ethylene glycol diisocrotonate, pentaerythritol diisocrotonate, and sorbitol tetraisocrotonate.

Examples of the maleate esters include ethylene glycol dimaleate, triethylene glycol dimaleate, pentaerythritol dimaleate, and sorbitol tetramaleate.

Specific examples of a monomer of the amide of an unsaturated carboxylic acid with an aliphatic polyvalent amine compound include methylenebis-acrylamide, methylenebis-methacrylamide, 1,6-hexamethylenebis-acrylamide, 1,6-hexamethylenebis-methacrylamide, diethylenetriamine trisacrylamide, xylylene bisacrylamide, and xylylene bismethacrylamide.

A urethane-based addition polymerizable compound produced by an addition reaction between an isocyanate and a hydroxy group is also preferred, and specific examples of such a compound include vinyl urethane compounds containing two or more polymerizable vinyl groups in one molecule obtained by adding a vinyl monomer containing a hydroxy group represented by the following formula (1) to a polyisocyanate compound having two or more isocyanate groups in one molecule.

CH₂═C(R¹)COOCH₂CH(R²)OH (1)

In the formula (1), R¹ and R² each independently represent H or CH₃.

In the invention, a cationic ring-opening polymerizable compound having at least one cyclic ether group such as an epoxy group or an oxetane group in the molecule can be favorably used as a UV curable resin (a polymerizable compound).

Examples of the cationic polymerizable compound include curable compounds containing a ring-opening polymerizable group, and among these, heterocyclic group-containing curable compounds are particularly preferred. Examples of such curable compounds include cyclic imino ethers such as epoxy derivatives, oxetane derivatives, tetrahydrofuran derivatives, cyclic lactone derivatives, cyclic carbonate derivatives, and oxazoline derivatives, and vinyl ethers, and among these, epoxy derivatives, oxetane derivatives, and vinyl ethers are preferred.

Preferred examples of the epoxy derivatives include monofunctional glycidyl ethers, polyfunctional glycidyl ethers, monofunctional alicyclic epoxies, and polyfunctional alicyclic epoxies.

Specific examples of compounds of the glycidyl ethers include diglycidyl ethers, (for example, ethylene glycol diglycidyl ether, bisphenol A diglycidyl ether, etc.), trifunctional or higher functional glycidyl ethers (for example, trimethylolethane triglycidyl ether, trimethylolpropane triglycidyl ether, glycerol triglycidyl ether, triglycidyl trishydroxyethyl isocyanurate, etc.), tetrafunctional or higher functional glycidyl ethers (for example, sorbitol tetraglycidyl ether, pentaerythritol tetraglycyl ether, polyglycidyl ethers of cresol novolac resins, polyglycidyl ethers of phenol novolac resins, etc.), alicyclic epoxies (polycyclohexyl epoxy methyl ethers of phenol novolac resins, etc.), and oxetanes.

As the polymerizable compound, an alicyclic epoxy derivative can be preferably used. An “alicyclic epoxy group” refers to a partial structure in which a double bond of a cycloalkene ring of a cyclopentene group, a cyclohexene group, or the like is epoxidized with a suitable oxidizing agent such as hydrogen peroxide or a peroxy acid.

As the alicyclic epoxy compound, a polyfunctional alicyclic epoxy compound having two or more cyclohexene oxide groups or cyclopentene oxide groups in one molecule is preferred. Specific examples of the alicyclic epoxy compound include 4-vinylcyclohexene dioxide, (3,4-epoxycyclohexyl)methyl-3,4-epoxycyclohexylcarboxylate, di(3,4-epoxycyclohexyl) adipate, di(3,4-epoxycyclohexylmethyl) adipate, bis(2,3-epoxycyclopentyl) ether, di(2,3-epoxy-6-methylcyclohexylmethyl) adipate, and dicyclopentadiene dioxide.

A normal glycidyl compound having an epoxy group but having no alicyclic structure in the molecule can be used alone or can also be used in combination with the above-mentioned alicyclic epoxy compound.

Examples of such a normal glycidyl compound include a glycidyl ether compound and a glycidyl ester compound, but it is preferred to use a glycidyl ether compound in combination.

Specific examples of the glycidyl ether compound include aromatic glycidyl ether compounds such as 1,3-bis(2,3-epoxypropyloxy)benzene, a bisphenol A type epoxy resin, a bisphenol F type epoxy resin, a phenol novolac type epoxy resin, a cresol novolac type epoxy resin, and a trisphenol methane type epoxy resin; and aliphatic glycidyl ether compounds such as 1,4-butanediol glycidyl ether, glycerol triglycidyl ether, propylene glycol diglycidyl ether, and trimethylolpropane triglycidyl ether. Examples of the glycidyl ester include glycidyl esters of linoleic acid dimers.

As the polymerizable compound, a compound having an oxetanyl group, which is a four-membered cyclic ether (hereinafter also simply referred to as “oxetane compound”) can be used. The oxetanyl group-containing compound is a compound having one or more oxetanyl groups in one molecule.

The content of the UV curable resin in the curable ink is preferably 80% by mass or more and 97% by mass or less, more preferably 85% by mass or more and 95% by mass or less.

According to this, the mechanical strength of the finally obtained three-dimensionally shaped article can be made particularly excellent. Further, the productivity of the three-dimensionally shaped article can be made particularly excellent.

### Other Component

The curable ink may contain a component other than the above-mentioned components. Examples of such a component include various coloring agents such as a pigment and a dye, a dispersant, a surfactant, a polymerization initiator, a polymerization accelerator, a solvent, a permeation accelerator, a wetting agent (a humectant), a fixing agent, an antifungal agent, a preservative, an antioxidant, a UV absorbing agent, a chelating agent, a pH adjusting agent, a thickening agent, a filler, an anti-aggregation agent, and a defoaming agent.

In particular, by including a coloring agent in the curable ink, the three-dimensionally shaped article 100 colored in a color corresponding to the color of the coloring agent can be obtained.

In particular, by including a pigment as the coloring agent, the light resistance of the curable ink and the three-dimensionally shaped article 100 can be made favorable. As the pigment, either an inorganic pigment or an organic pigment can be used.

Examples of the inorganic pigment include carbon blacks (C.I. Pigment Black 7) such as Furnace Black, Lamp Black, Acetylene Black, and Channel Black, iron oxide, and titanium oxide, and one pigment or a combination of two or more pigments selected from these can be used.

Among the inorganic pigments described above, in order to take on a preferred white color, titanium oxide is preferred.

Examples of the organic pigment include azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates (for example, basic dye type chelates, acidic dye type chelates, etc.), dye lakes (basic dye type lakes and acidic dye type lakes), nitro pigments, nitroso pigments, aniline black, and daylight fluorescent pigments, and one pigment or a combination of two or more pigments selected from these can be used.

In the case where the curable ink contains a pigment, the average particle diameter of the pigment is preferably 300 nm or less, more preferably 50 nm or more and 250 nm or less. According to this, the ejection stability of the curable ink and the dispersion stability of the pigment in the curable ink can be made particularly excellent, and also an image with a higher image quality can be formed.

Examples of the dye include acidic dyes, direct dyes, reactive dyes, and basic dyes, and one dye or a combination of two or more dyes selected from these can be used.

In the case where the curable ink contains a coloring agent, the content of the coloring agent in the curable ink is preferably 1% by mass or more and 20% by mass or less. According to this, particularly excellent concealing property and color reproducibility are obtained.

In particular, in the case where the curable ink contains titanium oxide as the coloring agent, the content of titanium oxide in the curable ink is preferably 12% by mass or more and 18% by mass or less, more preferably 14% by mass or more and 16% by mass or less. According to this, a particularly excellent concealing property is obtained.

In the case where the curable ink contains a pigment, when the curable ink further contains a dispersant, the dispersibility of the pigment can be made more favorable. As a result, a partial decrease in the mechanical strength due to uneven distribution of the pigment can be more effectively prevented.

The dispersant is not particularly limited, but examples thereof include dispersants which are commonly used for preparing a pigment dispersion liquid such as a polymeric dispersant. Specific examples of the polymeric dispersant include dispersants containing, as a main component, at least one of polyoxyalkylene polyalkylene polyamine, a vinyl-based polymer or copolymer, an acrylic polymer or copolymer, polyester, polyamide, polyimide, polyurethane, an amino-based polymer, a silicon-containing polymer, a sulfur-containing polymer, a fluorine-containing polymer, and an epoxy resin.

When the curable ink contains a surfactant, the abrasion resistance of the three-dimensionally shaped article 100 can be made more favorable. The surfactant is not particularly limited, however, for example, a polyester-modified silicone, a polyether-modified silicone, or the like as a silicone-based surfactant can be used, and in particular, it is preferred to use polyether-modified polydimethylsiloxane or polyester-modified polydimethylsiloxane.

The curable ink may contain a solvent. According to this, the adjustment of the viscosity of the curable ink can be favorably performed, and even if the curable ink contains a high viscosity component, the ejection stability of the curable ink by an inkjet method can be made particularly excellent.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetyl acetone; and alcohols such as ethanol, propanol, and butanol, and one solvent or a combination of two or more solvents selected from these can be used.

The viscosity of the curable ink is preferably 10 mPa·s or more and 25 mPa·s or less, more preferably 15 mPa·s or more and 20 mPa·s or less. According to this, the ejection stability of the ink by an inkjet method can be made particularly excellent. The “viscosity” as used herein refers to a value obtained by measurement at 25° C. using an E-type viscometer (for example, VISCONIC ELD, manufactured by Tokyo Keiki, Inc.).

In the production of the three-dimensionally shaped article 100, a plurality of types of curable inks may be used.

For example, a curable ink which contains a coloring agent (a color ink) and a curable ink which does not contain a coloring agent (a clear ink) may be used. According to this, for example, as a curable ink to be applied to a region which has an effect on the color tone in appearance of the three-dimensionally shaped article 100, a curable ink which contains a coloring agent is used, and as a curable ink to be applied to a region which does not have an effect on the color tone in appearance of the three-dimensionally shaped article 100, a curable ink which does not contain a coloring agent may be used. Further, in the finally obtained three-dimensionally shaped article 100, a plurality of types of curable inks may be used in combination such that a region (a coating layer) is provided by using a curable ink which does not contain a coloring agent on the outer surface of a region formed by using a curable ink which contains a coloring agent.

In addition, for example, a plurality of types of curable inks which contain a coloring agent having a different composition may be used. According to this, by using these curable inks in combination, an expressible color reproduction range can be widened.

In the case where a plurality of types of curable inks are used, it is preferred to use at least a cyan curable ink, a magenta curable ink, and a yellow curable ink. According to this, by using these curable inks in combination, an expressible color reproduction range can be further widened.

Further, by using a white curable ink in combination with the other colored curable inks, for example, the following effects are obtained. That is, the finally obtained three-dimensionally shaped article 100 can be configured to have a first region, to which a white curable ink is applied, and a region, which overlaps with the first region and is provided on the outer surface side of the first region, and to which a colored curable ink whose color is other than white is applied. According to this, the first region to which a white curable ink is applied can exhibit a concealing property, and the chroma of the three-dimensionally shaped article 100 can be further enhanced.

### 4. Sacrifice Layer Forming Ink

Next, the sacrifice layer forming ink will be described in detail.

The sacrifice layer forming ink contains at least a UV curable resin.

### UV Curable Resin

Examples of the UV curable resin constituting the sacrifice layer forming ink include the same UV curable resins as those exemplified as the constituent component of the curable ink described above.

The sacrifice layer forming ink preferably contains one or more curable components particularly selected from the group consisting of tetrahydrofurfuryl(meth)acrylate, ethoxyethoxyethyl(meth)acrylate, polyethylene glycol di(meth)acrylate, (meth)acryloyl morpholine, and 2-(2-vinyloxyethoxy)ethyl(meth)acrylate among various curable components. According to this, the sacrifice layer forming ink can be cured at a more appropriate curing rate, and the productivity of the three-dimensionally shaped article 100 can be made particularly excellent. Further, the mechanical strength and shape stability of the sacrifice layer 2 to be formed by curing the sacrifice layer forming ink can be made particularly excellent. As a result, when producing the three-dimensionally shaped article 100, the sacrifice layer 2 as the lower layer (first layer) can more favorably support the curable ink for forming the upper layer (second layer). Due to this, undesirable deformation (particularly, sagging or the like) of the layer 1 can be more favorably prevented (the sacrifice layer 2 which is the first layer functions as a support material), and thus, the dimensional accuracy of the finally obtained three-dimensionally shaped article 100 can be made particularly excellent.

The content of the UV curable resin in the sacrifice layer forming ink is preferably 83% by mass or more and 98.5% by mass or less, more preferably 87% by mass or more and 95.4% by mass or less. According to this, the shape stability of the sacrifice layer 2 to be formed can be made particularly excellent. As a result, the dimensional accuracy of the finally obtained three-dimensionally shaped article 100 can be made particularly excellent.

### Other Component

The sacrifice layer forming ink may contain a component other than the above-mentioned components. Examples of such a component include various coloring agents such as a pigment and a dye, a dispersant, a surfactant, a polymerization initiator, a polymerization accelerator, a solvent, a permeation accelerator, a wetting agent (a humectant), a fixing agent, an antifungal agent, a preservative, an antioxidant, a UV absorbing agent, a chelating agent, a pH adjusting agent, a thickening agent, a filler, an anti-aggregation agent, and a defoaming agent.

In particular, by including a coloring agent in the sacrifice layer forming ink, the visibility of the sacrifice layer 2 is improved, and in the finally obtained three-dimensionally shaped article 100, at least a part of the sacrifice layer 2 can be more reliably prevented from being undesirably left.

Examples of the coloring agent constituting the sacrifice layer forming ink include the same coloring agents as those exemplified as the constituent component of the curable ink described above, however, the coloring agent is preferably a coloring agent which gives a color different from the color to be visually recognized in appearance of the three-dimensionally shaped article 100 overlapping with the sacrifice layer 2 formed using the sacrifice layer forming ink when observed from the normal direction of the surface of the three-dimensionally shaped article 100. According to this, the effect as described above is more remarkably exhibited.

In the case where the sacrifice layer forming ink contains a pigment, when the sacrifice layer forming ink further contains a dispersant, the dispersibility of the pigment can be made more favorable. Examples of the dispersant constituting the sacrifice layer forming ink include the same dispersants as those exemplified as the constituent component of the curable ink described above.

The viscosity of the sacrifice layer forming ink is preferably 10 mPa·s or more and 30 mPa·s or less, more preferably 15 mPa·s or more and 25 mPa·s or less.

According to this, the ejection stability of the sacrifice layer forming ink by an inkjet method can be made particularly excellent.

In the production of the three-dimensionally shaped article 100, a plurality of types of sacrifice layer forming inks may be used.

### 5. Three-Dimensionally Shaped Article

The three-dimensionally shaped article according to the invention can be produced by using the production method and the production apparatus as described above. According to this, the three-dimensionally shaped article produced with high dimensional accuracy can be provided.

The use of the three-dimensionally shaped article according to the invention is not particularly limited, however, examples of the use include ornaments and exhibits such as dolls and figures; and medical devices such as implants.

Further, the three-dimensionally shaped article according to the invention may be applied to any of prototypes, mass-produced products, and custom-made products.

Further, the three-dimensionally shaped article according to the invention may be a model (for example, a model of a vehicle such as an automobile, a motorcycle, a ship, or an airplane, a building, a living thing such as an animal or a plant, a natural thing (non-living thing) such as a stone, any of a variety of foods, or the like).

Hereinabove, preferred embodiments of the invention have been described, however, the invention is not limited thereto.

For example, in the three-dimensionally shaped article production method according to the invention, a pre-treatment step, an intermediate treatment step, or a post-treatment step may be performed as needed.

Examples of the pre-treatment step include a stage cleaning step.

Examples of the post-treatment step include a washing step, a shape adjustment step in which deburring or the like is performed, and an additional curing treatment for increasing the curing degree of a curable resin.

Further, the invention may be applied to a powder stacking method (that is, a method in which a series of operations including an operation of forming a layer using a powder and an operation of forming a cured portion by applying a curable ink to a given position of the layer are repeated, whereby a three-dimensionally shaped article is obtained as a stacked body having a plurality of layers provided with a cured portion).

The entire disclosure of Japanese Patent Application No. 2014-212570, filed Oct. 17, 2014 is expressly incorporated by reference herein.

What is claimed is:

1. A three-dimensionally shaped article production method, which is a method for producing a three-dimensionally shaped article by stacking a layer, comprising:
ejecting a curable ink containing a UV curable resin, thereby forming the layer;
irradiating the ejected curable ink with an ultraviolet ray; and
flattening the layer by removing at least a part of the layer.

2. The three-dimensionally shaped article production method according to claim 1, wherein in the flattening of the layer, after stacking a plurality of the layers, at least a part of the uppermost layer and the lower layer of the uppermost layer of the plurality of the layers are removed.

3. The three-dimensionally shaped article production method according to claim 1, wherein in the ejecting of a curable ink, a sacrifice layer forming ink containing a UV curable resin for forming a sacrifice layer is ejected into a region, which is adjacent to a region to become the outermost layer of the three-dimensionally shaped article, and is on the surface side of the outermost layer.

4. The three-dimensionally shaped article production method according to claim 3, wherein in the flattening of the layer, the layer including the sacrifice layer is flattened.

5. The three-dimensionally shaped article production method according to claim 1, wherein the flattening of the layer performed using one member selected from the group consisting of a rotary cutter, an end mill, a grinder, and a laser.

6. A three-dimensionally shaped article production apparatus, which is an apparatus for producing a three-dimensionally shaped article by stacking a layer, comprising:
a shaping section in which the three-dimensionally shaped article is shaped;
an ejection section which ejects a curable ink containing a UV curable resin, thereby forming the layer on the shaping section;
a UV irradiation section which irradiates the ejected curable ink with an ultraviolet ray; and
a flattening unit which flattens the layer by removing at least a part of the layer.

7. A three-dimensionally shaped article, which is produced by the three-dimensionally shaped article production method according to claim 1.

8. A three-dimensionally shaped article, which is produced by the three-dimensionally shaped article production method according to claim 2.

9. A three-dimensionally shaped article, which is produced by the three-dimensionally shaped article production method according to claim 3.

10. A three-dimensionally shaped article, which is produced by the three-dimensionally shaped article production method according to claim 4.

10. A three-dimensionally shaped article, which is produced by the three-dimensionally shaped article production method according to claim 5.

11. A three-dimensionally shaped article, which is produced with the three-dimensionally shaped article production apparatus according to claim 6.
